(19) United States
(12) Patent Application Publication
(10) Pub. No.: US 2012/0093287 A1
(43) Pub. Date: Apr. 19, 2012

(54) TWO UNIT PORTABLE X-RAY SCANNER

(76) Inventor: SATPAL SINGH, Potomac, MD (US)

(21) Appl. No.: 12/906,978

(22) Filed: Oct. 18, 2010

(51) Int. Cl. G01N 23/04

(52) U.S. Cl. 378/57

(57) ABSTRACT

This invention describes a novel transmissive x-ray scanner system that is mounted on two small mobile or robotic platforms and used for security inspection of unidentified parcels at airports, buildings, roadside, or of large objects such as cars that are much larger than the scanner itself. The system comprises of a two mobile platforms, one carrying the x-ray or the radiation source and the other the detector. The method comprises the steps of moving the two mobile platforms and locating them on opposing sides of the object, then holding the platforms stationary and moving only the detector and the source to scan the object.

### BACKGROUND OF THE INVENTION

1. Field of the Invention

This invention describes a novel transmissive x-ray scanner system that is mounted on small mobile or robotic platforms and used for security inspection of unidentified parcels at airports, buildings, roadside, or of large objects such as cars that are much larger than the scanner itself.

2. Description of the Related Art

X-ray scanners for security inspection can be classified as either stationary, or mobile. Existing mobile scanners are large, truck mounted and can be used only for scanning objects located outside of buildings where there is enough space for a truck to maneuver around the object. These large truck mounted systems are not suitable for scanning parcels or unidentified baggage left in airport lobbies, buildings, etc. Further, the truck mounted systems employ either a source or detector mounted on a boom that is deployed over and around the object. These booms are large, of fixed size and therefore not suitable for use in small spaces. If smaller sized booms were to be made, then it would be impossible to scan objects that are higher than the height of the boom. One might think of mounting the detectors and source on two smaller and separate mobile platforms, but then one immediately encounters the problems of precisely synchronizing the movement of the two platforms which becomes almost an impossible task if the surface over which the two platforms travel is uneven or has bumps.

An alternative technique that does not use the booms is the backscatter method. In accordance with this method the x-ray radiation is emitted from a source towards the object to be scanned, and the radiation scattered backwards by the object is detected by the detectors located on the same side as the source. While this technique gets rid of the boom and is compacter in size, the backscatter technique has a serious disadvantage that it cannot be used for dense objects as the backscattered signal is weak or of low energy and is unable to penetrate back out of the dense object.

Accordingly, the objects of this invention are to overcome the above limitations as stated next.

### Objects of the Invention

It is, accordingly, an object of the invention to provide a method of deploying small x-ray scanners on small mobile platforms suitable for inspections of packets left in the lobbies of airports or buildings, or of unidentified objects left outdoors on the roadside.

It is also an object of the invention to build small sized x-ray scanners that can be used to scan objects much larger than the size of the scanner itself or the length of the detector arms.

These and other objects will become apparent in the description that follows.

### SUMMARY OF THE INVENTION

The x-ray scanning system in accordance with this invention is implemented on two mobile platforms, the first platform being referred to as the source unit which carries the x-ray radiation source. The second platform is referred to as the detector unit and it carries the x-ray detector. In order to scan an object, the source unit and detector unit are moved to generally opposing sides of an object to be scanned. The source unit has a x-ray source which emits a fan shaped beam. This fan shaped beam is directed towards the object. After passing through the object, this fan shaped beam is received by the detector. The detector is comprised of a linear array of small detector elements, and the entire linear array or the detector is held horizontally and can move up and down over a vertical member attached to the platform comprising the detector unit. To scan the object, the source mounted on the source unit is simply tilted vertically up or down and at the same time the horizontally held detector is moved up or down over the vertical member it is attached to. Once the scan is completed, if desired, the height of the x-ray source is changed and the scan repeated thereby yielding a scanned image from a different angle or a different view. Thus different views of the object can be obtained and analyzed to obtain a better understanding of the object structure or its composition. For long objects such as a car, repeated scanning is done by moving the source unit and the detector unit to different positions along the length of the car. Further by a combination of raising and tilting the source to move the beam higher and directing the beam upwards, objects much taller than the height of the scanner itself can be scanned. Using this approach, the height of the object is not limited to the height of a cross boom used in existing truck mounted mobile scanners.

In another embodiment of the invention, the x-ray source emits a cone shaped radiation rather than fan shaped. According to this embodiment, the x-ray source is not tilted or rotated, but the detector alone is moved up or down to scan the object.

There are several embodiments, objects and advantages to this invention that will be apparent to one skilled in the art. The accompanying figures and description herein should be considered illustrative only and not limiting or restricting the scope of invention, the scope being indicated by the claims.

### BRIEF DESCRIPTION OF THE DRAWINGS

FIG. 1 shows a simplified schematic of a preferred embodiment of this invention.

FIG. 2 shows a simplified schematic of an alternative embodiment of this invention.

### DETAILED DESCRIPTION OF THE PREFERRED EMBODIMENTS

In describing the preferred embodiment and its alternatives, specific terminology will be used for the sake of clarity. However, the invention is not limited to the specific terms so used, and it should be understood that each specific term includes all its technical equivalents which operate in a similar manner to accomplish similar purpose.

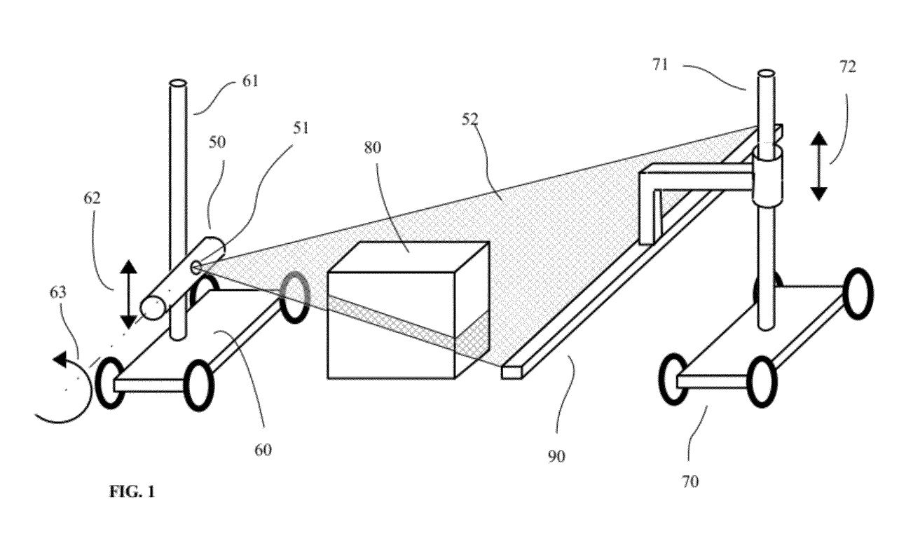

FIG. 1 shows a preferred embodiment of the present invention. For the sake of clarity in the drawings, the ordinary details relating to the mechanics and electronics of the system have been omitted as these are well known to a person skilled in the field.

As shown in FIG. 1, the scanning method employs two mobile platforms. The first platform, 60 is hereafter referred to as the source platform or the source unit, and the second platform, 70 is hereafter referred to as the detector platform or the detector unit. The use of two platforms realizes a means to change the separation between the source and detector to accommodate between them an object 80 to be scanned.

The source unit 60 carries a x-ray source 50 which can instead be a gamma source or any other suitable source of radiation. The source 50 has a focal point 51 from which a conically diverging beam emanates which is then shaped into a fan beam 52 by a collimator not shown for simplicity but well known to a person skilled in the art. The source is attached to a vertical member 61 by a suitable means such that the source 50 can be raised or lowered in height as indicated by arrow 62. Further the means of attachment of source 50 to the member 61 allows for the source to be tilted or rotated as indicated by arrow 63. Not shown for simplicity to avoid the clutter in the drawing, but well known to a person skilled in the art, are the details of the mechanics and electronics like the x-ray generator electronics, the motors and servos and their associated control electronics, etc.

The detector unit 70 comprises of a vertical member 71 that supports a detector 90 horizontally as shown. The detector 90 is attached to the member 71 by a suitable means that also allows the movement of the detector vertically up and down as indicated by the arrow 72. Not shown to avoid the clutter and to keep the drawing simple is a means to swivel or orient the detector 90 towards the focal point of source 51 as the height of detector 90 is changed. Also not shown for simplicity is the detector electronics, the motors and servos and their control systems, the data acquisition and display electronics and other details which are well known to a person skilled in the art.

It should be noted that as would be well understood by a person skilled in the art, that in addition to the two platforms 60 and 70, there could be a third unit for control, computing and display that could be housed in a remote location.

As shown in FIG. 1, the source unit 60 and detector unit 70 are moved to generally opposing sides of an object 80 to be scanned. The path of radiation 52 from source 50 to detector 90 is a fan shaped beam and intersects object 80 over a thin slice or a narrow region. The beam 52 after it passes through the object 80 is detected by the detector 90 and the detected signal represents the line projection of the object. As the height of the detector 90 is raised, the source 50 is tilted or rotated about a horizontal axis as indicated by the arrow 63, thereby sweeping or scanning the beam 52 over the object 80. As is well known to a person skilled in the art, the collection of line projections can be displayed on a screen to display a scanned image of the object.

It should be noted that the source 50 can be lowered close to the ground through a cut out in the floor of the source unit 60, or alternatively, the source 50 could overhang the side of the platform 60 so that it can be lowered to the ground. Lowering the source 50 to the ground level allows to scan the bottom portions of the object 80.

It should be further noted that in order to scan a long object like a car, first a small section of the car is scanned. Next the source unit 60 and detector unit 70 are moved further along the length of the car and another section of the car scanned. Proceeding thus, the entire length of the car can be scanned. It should also be noted that for such an application, one could instead keep the platforms 60 and 70 stationary and move the car instead.

In an alternative form of embodiment, the radiation beam coming out of source 50 need not be shaped into a fan beam by the use of a collimator, but instead could be a cone beam. In such a case, there is no need to tilt or swivel the source as indicated by arrow 63 in FIG. 1.

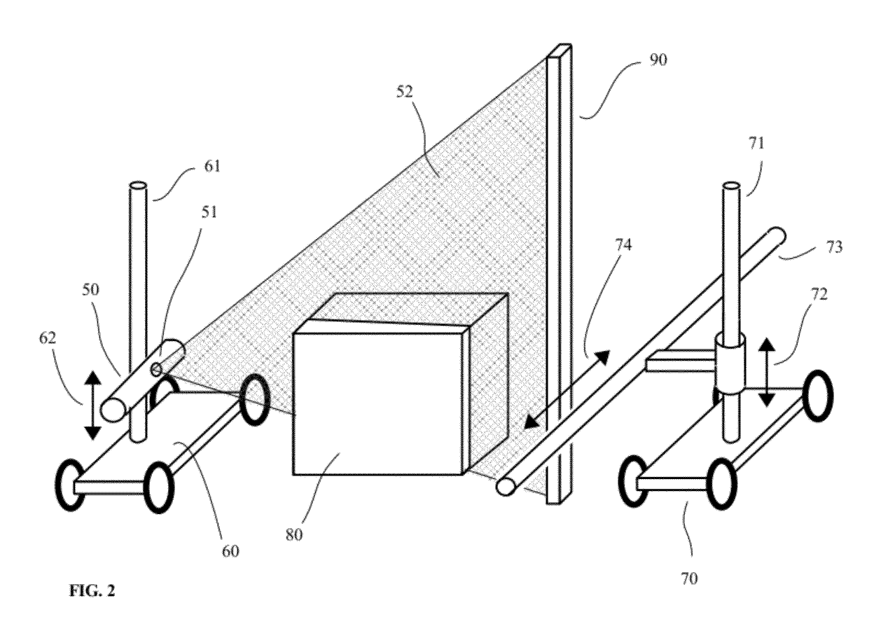

An alternative embodiment of the invention is shown in FIG. 2. As shown, the beam 52 and the detector 90 are now vertically arranged. The motion of the detector 90 is horizontal as indicated by arrow 74 and the source 50 is now rotated about a vertical axis instead of horizontal which was the case in FIG. 1. A further variation of this embodiment would be that the source 50 emits a cone beam rather than a fan beam, and in this case there would be no need to swivel the source about a vertical axis.

It should be noted that it is not necessary to keep the detector either horizontal or vertical, but could be at any of several different angles which allow for a radiation to travel from source through the object to the detector. Further, in the foregoing description, certain modes of movement of source and detector have been described to facilitate the ease of understanding, but there are several different modes possible that would implement the relative motion between the detector and the object that would result in the scan of the object.

It should be noted that multiple views can be obtained by positioning the source 50 at different heights, and also by positioning the platforms 60 and 70 at different angles with respect to the object. These multiple views can then be analyzed by a computing means to determine the 3D structure or composition of the object 80 being scanned.

It should further be noted that the source unit 60 and the detector unit 70 need not be mounted on wheels or be mobile, they could just be dropped at generally two opposing sides of the object to be scanned.

In the above description, the details of the means to generate radiation, the means to translate the detector with respect to the object, the detector electronics, the data acquisition, the image generation, the analysis of detected signals from the detectors, and other details have been omitted as they are well known to a person skilled in the art.

The foregoing description of the invention and its embodiments should be considered as illustrative only of the concept and principles of the invention. The invention may be configured in a variety of ways, shapes and sizes and is not limited to the description above. Numerous applications of the present invention will readily occur to those skilled in the art. Therefore, it is desired that the scope of the present invention not be limited by the description above but by the claims presented herein.

The invention claimed is:

1. A device, to inspect an object, comprising of:
a source of radiation mounted on a source unit, further said source emitting a beam of radiation;
a detector mounted on a detector unit, further said detector oriented to receive said radiation;
a means to change the relative separation between said source unit and said detector unit;
a means to position said source unit and said detector unit on generally opposing sides of an object to scan such that the path of said radiation from said source to said detector is a fan shaped beam and intersects said object;
a means to change the position of said detector relative to said object while keeping stationary both of said source unit and said detector unit such that said fan shaped beam scans over a volume of said object to be inspected; and
a computing means to analyze the data from said detector and thereby make a determination regarding the nature of composition of said object.

2. A device of claim 1 further comprising of:
a means to adjust the height of said source such that said radiation remains generally directed towards said detector.

3. A device of claim 1 further comprising of:
a means to adjust the orientation of said detector so that it points to said source.

4. A device of claim 2 further comprising of:
a means to adjust the orientation of said detector so that it points to said source

5. A method to inspect an object comprising the steps of:
using a radiation source mounted on a source unit to generate a beam of radiation;
orienting a detector mounted on a detector unit to receive and detect said radiation;
using a means to change the relative separation between said detector unit and said source unit,
using a means to position said source unit and said detector unit on generally opposing sides of an object to scan such that the path of said radiation from said source to said detector is a fan shaped beam and intersects said object;
using a means to change the position of said detector relative to said object while keeping stationary both of said source unit and said detector unit such that said fan shaped beam scans over a volume of said object to be inspected; and
using a computing means to analyze the data from said detector and thereby make a determination regarding the nature of composition of said object.

6. A method of claim 5 further comprising the steps of:
using a means to adjust the height of said source such that said radiation remains generally directed towards said detector.

7. A method of claim 5 further comprising the steps of:
using a means to adjust the orientation of said detector so that it points to said source.

8. A method of claim 6 further comprising the steps of:
using a means to adjust the orientation of said detector so that it points to said source.

9. A method of claim 6 further comprising the steps of:
keeping the height of said source fixed and obtaining a first scan by moving said detector;
changing the height of said source and obtaining a second scan by moving said detector;
obtaining multiple scans comprising of at least said first scan and said second scan; and
analyzing data from said multiple scans to analyze said object.

10. A method of claim 5 further comprising the steps of:
keeping stationary said source unit and said detector unit and obtaining a first scan;
changing the position of at least one of said source unit and said detector unit and obtaining a second scan;
obtaining multiple scans comprising of at least said first scan and said second scan; and analyzing data from said multiple scans to analyze said object.
